(19) United States
(12) Patent Application Publication
(10) Pub. No.: US 2023/0231442 A1
(43) Pub. Date: Jul. 20, 2023

(54) MOTOR

(71) Applicant: MINEBEA MITSUMI Inc., Nagano (JP)

(72) Inventor: Kouji KEBUKAWA, Kitasaku-gun, Nagano (JP)

(21) Appl. No.: 18/000,404

(22) PCT Filed: Jun. 7, 2021
(86) PCT No.: PCT/JP2021/021488

§ 371 Date: Dec. 1, 2022

(30) Foreign Application Priority Data
Jun. 8, 2020 (JP) 2020-099712

(51) Int. Cl. H02K 7/08; H02K 1/2706

(52) U.S. Cl. CPC H02K 7/085; H02K 1/2706; H02K 2213/03

(57) ABSTRACT

The application is a motor capable of reducing vibration. A motor includes a shaft, a pair of bearings, a sleeve accommodating the pair of bearings, a magnet fixed at one of the shaft and sleeve, a coil fixed at the other of the shaft or the sleeve and opposing the magnet, and an elastic member disposed between the pair of bearings and satisfying Expression 1. D is an outer diameter [m] of the elastic member, d is a wire diameter (p [m] of the elastic member, γ is a unit volume weight [kg/m³] of a material of the elastic member, S is a no-load rotation number [rotation/min] of the shaft, and g is gravitational acceleration.

$$S < \frac{20 d \sqrt{\frac{gG}{2 γ}}}{{π D}^{2}} \qquad ( 1 )$$

### TECHNICAL FIELD

The present invention relates to a motor.

### BACKGROUND ART

A conventionally known motor includes a bearing portion configured of a pair of bearings, a spring (elastic member) disposed between the pair of bearings and applying preload to outer rings of both bearings, and a sleeve configured to hold the outer rings of the pair of bearings (see, for example, Patent Document 1).

### CITATION LIST

### Patent Literature

Patent Document 1: JP 2018-145897 A

### SUMMARY OF INVENTION

### Technical Problem

In the motor as described above, a phenomenon may occur. In the phenomenon, large vibration may be generated in a wide rotation number range of a using rotation number of the motor. When the large vibration is generated in the motor, the load on the bearing increases, and thus there may be a concern. In this concern, the durability of the motor is affected, and the application of the pressure to the bearing by the spring is insufficient.

Therefore, the present invention has been contrived in view of the above situation, and an example of an object of the present invention is to provide a motor capable of reducing the vibration.

### Solution to Problem

The object described above is achieved by the present invention below. That is, one aspect of a motor according to the present invention includes a shaft, a pair of bearings fixed at the shaft, a sleeve accommodating the pair of bearings, a magnet directly or indirectly fixed at one of the shaft and the sleeve, a coil directly or indirectly fixed at the other of the shaft and the sleeve and opposing the magnet, and an elastic member disposed between the pair of bearings, the elastic member satisfying the following Expression 1:

$$Expression 1$$

$$S < \frac{20 d \sqrt{\frac{gG}{2 γ}}}{{π D}^{2}}$$

In the above Expression 1, D represents an outer diameter [m] of the elastic member, d represents a wire diameter φ [m] of the elastic member, γ represents a unit volume weight [kg/m³] of a material of the elastic member, and S represents a no-load rotation number [rotation/min] of the shaft, and g represents gravitational acceleration.

As the above-described one aspect of the motor according to the present invention, the following Expression 1a may be satisfied instead of the above Expression 1:

S<1.42×10⁴×d/D² Expression 1a

In the above Expression 1a, D represents an outer diameter [m] of the elastic member, d represents a wire diameter φ [m] of the elastic member, and S represents a no-load rotation number [rotation/min] of the shaft.

Further, as the above-described one aspect of the motor according to the present invention, the following Expression 1b is preferably satisfied instead of the above Expression 1:

S<0.71×10⁴×d/D² Expression 1b

In the above Expression 2a, D represents an outer diameter [m] of the elastic member, d represents a wire diameter φ [m] of the elastic member, and S represents a no-load rotation number [rotation/min] of the shaft.

Another one aspect of the motor according to the present invention includes a shaft, a pair of bearings fixed at the shaft, a sleeve accommodating the pair of bearings, a magnet fixed at one of the shaft and the sleeve, a coil fixed at the other of the shaft and the sleeve and opposing the magnet, and an elastic member disposed between the pair of bearings, the elastic member satisfying the following Expression 2:

$$Expression 2$$

$$S > \frac{60 d \sqrt{\frac{gG}{2 γ}}}{{π D}^{2}}$$

In the above Expression 2, D represents an outer diameter [m] of the elastic member, d6 represents a wire diameter φ [m] of the elastic member, γ represents a unit volume weight [kg/m³] of a material of the elastic member, and S represents a no-load rotation number [rotation/min] of the shaft, and g represents gravitational acceleration.

As the above-described one aspect of the motor according to the present invention, the following Expression 2a may be satisfied instead of the above Expression 2:

S>4.20×10⁴×d/D² Expression 2a

In the above Expression 2a, D represents an outer diameter [m] of the elastic member, d represents a wire diameter φ [m] of the elastic member, and S represents a no-load rotation number [rotation/min] of the shaft.

Further, as another one aspect described above of the motor according to the present invention, the following Expression 2b is preferably satisfied instead of the above Expression 2:

S>10.78×10⁴×d/D² Expression 2b

In the above Expression 2b, D represents an outer diameter [m] of the elastic member, d represents a wire diameter φ [m] of the elastic member, and S represents a no-load rotation number [rotation/min] of the shaft.

### BRIEF DESCRIPTION OF DRAWINGS

FIG. 1 is a cross-sectional view of an inner rotor type motor according to an embodiment, the embodiment being one example of the present invention.

FIG. 2 is a cross-sectional view of an outer rotor type motor according to another embodiment, another embodiment being one example of the present invention.

FIG. 3 is an enlarged view enlarged by extracting only a spring (elastic member) used in the motors according to the embodiments.

FIG. 4 is a graph showing a result of verifying a generation state of vibration modes of natural vibrations of the spring (elastic member) according to the embodiment. In the graph, orders of the vibration modes of generated natural vibrations are plotted on a horizontal axis, and vibration frequencies (Hz) of each natural vibration are plotted on a vertical axis.

FIG. 5 is a graph showing a region satisfying Expression 1a in the present invention in a specific condition X by a diagonal line hatching in the graph in FIG. 4.

FIG. 6 is a graph showing a region satisfying Expression 2a in the present invention in the specific condition X by the diagonal line hatching in the graph in FIG. 4.

### DESCRIPTION OF EMBODIMENTS

A motor according to embodiments of the present invention will be described below with reference to the drawings.

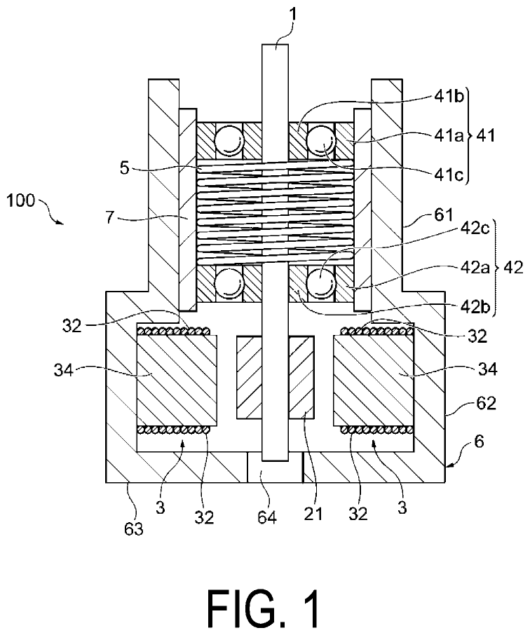

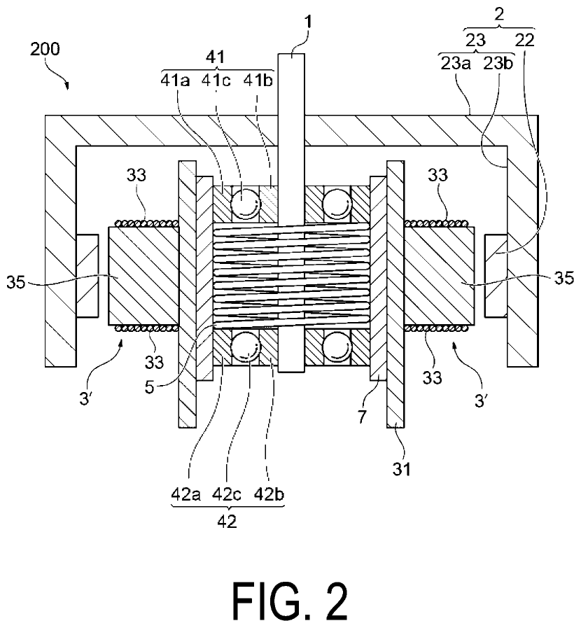

The motor according to the embodiments of the present invention may be any type of motor of an inner rotor type illustrated in FIG. 1 and an outer rotor type illustrated in FIG. 2. Here, FIG. 1 is a cross-sectional view of a motor 100 of the inner rotor type according to the embodiment of the present invention, and FIG. 2 is a cross-sectional view of a motor 200 of the outer rotor type according to another embodiment of the present invention.

Note that in the description of the present embodiments, “upper” and “lower” refer to an up and down relationship in FIG. 1 or FIG. 2, and do not necessarily correspond to an up and down relationship in the gravitational direction. Further, in the description of the present embodiments, “left” and “right” refer to a left and right relationship in FIG. 1 or FIG. 2.

First, the inner rotor type motor 100 will be described.

As illustrated in FIG. 1, the motor 100 includes a shaft 1, a pair of bearings 41 and 42 fixed at the shaft 1, a sleeve 7 accommodating the pair of bearings 41 and 42, a spring (elastic member) 5 disposed between the pair of bearings 41 and 42, a magnet 21 indirectly fixed at the shaft 1 via a rotor yoke (not illustrated), a stator 3 including a coil 32 opposing the magnet 21, and a housing 6 accommodating or fixing the stator 3 and the sleeve 7 inside and supporting the stator 3 and the sleeve 7.

The shaft 1 is located at a center viewed from above the motor 100 and extends in the upper and lower direction. The shaft 1 is formed with aluminum, for example, for weight reduction. The shaft 1 is located in the housing 6 except for the upper end portion, and the upper end portion protrudes upward from the housing 6, so that the rotation drive force of the motor 100 can be extracted to the outside. Note that in the present embodiment and embodiments described below, “circumferential direction” refers to the circumferential direction of a circle about the rotation axis of the shaft 1.

The housing 6 includes a small diameter portion 61 at the upper, a large diameter portion 62 at the lower, and a bottom plate 63 closing (however there is an opening 64 having a circular shape at a position opposing the lower end portion of the shaft 1) an opening at the large diameter portion 62 side (lower side). The housing 6 is made of, for example, a resin material or a metal material. In an internal space of the housing 6, not only the magnet 21, the rotor including the rotor yoke, and the stator 3 including the coil 32, but also most of the other components of the motor 100 are accommodated.

Note that the housing 6 may be formed by integrally molding a member having a cup shape formed from, for example, the small diameter portion 61, the large diameter portion 62 and the bottom plate 63, or may be formed by separately molding the small diameter portion 61, and the large diameter portion 62 and the bottom plate 63, and bonding both by a known method. For the heat dissipation of the internal space of the motor 100, for example, the bottom plate 63 may be further perforated, or the bottom plate 63 may be formed of a material including openings having a mesh shape or the like. Alternatively, the housing may have no bottom plate 63 and open at a lower portion.

The rotor is fixed at the lower side of the shaft 1 in the housing 6. The rotor includes the rotor yoke (not illustrated) fixed at the shaft 1, and the magnet 21 attached at the outer circumference of the rotor yoke.

The rotor yoke is formed of a magnetic body, but may be formed of a non-magnetic body such as aluminum when there is no problem in characteristics.

On the other hand, the magnet 21 is attached at an outer circumference surface of the rotor yoke so as to oppose the coil 3 of the stator described below. The magnet 21 has an annular shape or a cylindrical shape, and includes a region magnetized to the north pole and a region magnetized to the south pole, alternately provided at along the circumferential direction at a constant period.

The stator 3 surrounding the magnet 21 includes a stator core, only a teeth portion 34 of the stator core being illustrated, and a coil 32.

The stator core includes an annular portion (core) (not illustrated) and a plurality of the teeth portions 34, the annular portion being a stacked body of silicon steel sheets or the like, and being disposed coaxially with the shaft 1. The plurality of teeth portions 34 extend from the annular portion toward the magnet 21. The stator 3 is held by the housing 6 described in detail later from the outside of the annular portion.

The coil 32 is wound around each of the teeth portions 34 and indirectly fixed at the sleeve 7 via the teeth portion 34 and housing 6. The stator core and the coil 32 are insulated from each other by an insulator (not illustrated) formed of an insulating material. Note that, instead of the insulator, an insulating film may be coated at the surface of the stator core to insulate the stator core from the coil 32.

In the motor 100 according to the present embodiment, a magnetic field generated by applying a controlled current to the coil 32 causes attraction or repulsion acting between the coil 32 and the magnet 21, so that a rotational force acts at the magnet 21 and the shaft 1 rotates together, the magnet 21 being indirectly fixed at the shaft 1 via the rotor yoke.

The shaft 1 is fixed in a state of being fitted into the bearings 41 and 42. Two bearings 41 and 42, in other words, a first bearing 41 and a second bearing 42 are attached and lined at a constant interval at the upper of the shaft 1, the upper being opposite to a side, the rotor being fixed at the side. The second bearing 42 is located closer to a lower side, the rotor being fixed closer to the lower side. The first bearing 41 is located at an upper end side.

The bearings 41 and 42 are so-called ball bearings including outer rings 41a and 42a, inner rings 41b and 42b, and balls (bearing balls) 41c and 42c interposed between the outer rings 41a and 42a and the inner rings 41b and 42b. The balls 41c and 42c roll between the outer rings 41a and 42a and the inner rings 41b and 42b so that a rotational resistance of the inner rings 41b and 42b with respect to the outer rings 41a and 42a is significantly reduced. The bearings 41 and 42 are formed, for example, from a hard metal such as iron, or a ceramic in consideration of their function. The shaft 1 is fixed at the inner rings 41b and 42b, and is rotatable with respect to the outer rings 41a and 42a.

The bearings 41 and 42 are accommodated in the sleeve 7. The sleeve 7 is a member having a tubular shape (in particular, cylindrical shape), and is formed of a plastic and a metal, for example. Although there is no unevenness at the outer circumference surface of the sleeve 7, a locking groove (not illustrated) is provided at the inner circumference surface of the sleeve 7, and the outer rings 41a and 42a of the bearings 41 and 42 are locked and positioned. Note that the outer rings 41a and 42a of the bearings 41 and 42 may be fixed at the sleeve 7 by any fixing method, such as fixing using an adhesive, in addition to the locking structure described in the present embodiment.

The spring (elastic member) 5 is disposed between the pair of bearings 41 and 42. Both ends of the spring 5 in a compressed state are in contact with the outer rings 41a and 42a, so that preload is applied to the bearings 41 and 42. In the present embodiment, the vibration of the motor 100 can be suppressed by adjusting the spring 5 to an appropriate condition. The condition of the spring 5 will be described in detail later.

In the present embodiment, the shaft 1, the sleeve 7, the spring 5, the first bearing 41, and the second bearing 42 constitute one cartridge member. By forming the cartridge member as one component, the cartridge member being in a state where the sleeve 7, the spring 5, the first bearing 41, and the second bearing 42 are assembled to the shaft 1 in advance, assembly work is facilitated when manufacturing the cartridge member. In addition, for example, when the bearings 41 and 42 are broken, it is sufficient to replace the cartridge member, and thus the replacement operation is easy, making it possible to perform a repair in a simple operation and also leading to a low cost.

Also, it is relatively easy to adjust the rotational balance in a state of the cartridge member being in a stage with a small number of parts. Thus, by adjusting the rotational balance in the state of the cartridge member, the operation of the rotational balance can be omitted when manufacturing or repairing the motor or after manufacturing or repairing the motor, or the operation by a simple operation can be performed, and thus the manufacturing or repairing operation can be simplified. Thus, this may also lead to the low cost.

In particular, in the case of the cartridge member including the rotor 1, it is easy to assemble the cartridge member as a sub-assembly, and as a result, centering at the time of assembling each member in the cartridge member is easy, so that the motor 100 can be easily manufactured.

The outer circumference surface of the sleeve 7 is fixed at and supported by an inner circumference surface of the small diameter portion 61 of the housing 6. Thus, the shaft 1 is supported so as to be freely rotatable

relative to the housing 6, and the rotational force of the motor 100 can be extracted from the shaft 1.

Next, the outer rotor type motor 200 will be described.

Note that the same reference numerals as those of the motor 100 according to the above-described embodiment are given to members having the same configuration and functions as the motor 100, and a detailed description of the members will be omitted.

As illustrated in FIG. 2, the motor 200 includes a shaft 1, a pair of bearings 41 and 42 fixed at the shaft 1, a sleeve 7 accommodating the pair of bearings 41 and 42, a spring (elastic member) 5 disposed between the pair of bearings 41 and 42, a magnet 22 indirectly fixed at the shaft 1 via a rotor yoke 23, and a stator 3′ including a coil 33 opposing the magnet 22.

The shaft 1 is located at a center viewed from above the motor 200 and extends in the upper and lower direction. The center of a disc portion 23a of the rotor yoke 23 is fixed at the upper side of the shaft 1. The rotor yoke 23 is constituted by the disc portion 23a having a disc shape and a cylindrical portion 23b connecting to the outer circumference of the disc portion 23a and extending downward.

The rotor yoke 23 is formed of a magnetic body, but may be formed of a non-magnetic body such as aluminum, plastic, and the like when there is no problem in characteristics.

The rotor 2 is constituted by the rotor yoke 23 fixed at the shaft 1 and the magnet 22 attached at the inner circumference of the cylindrical portion 23b in the rotor yoke 23. The rotor 2 rotates together with the rotation of the shaft 1, a center of the disc portion 23a of the rotor yoke 23 being fixed at the shaft 1.

The magnet 22 is disposed so as to surround and oppose the coil 33 of the stator 3′ described below. The magnet 22 includes regions magnetized to the north pole and regions magnetized to the south pole, alternately provided at along the circumferential direction at a constant period.

The stator 3′ surrounded by the magnet 22 includes a stator core (a part is not illustrated) and the coil 33.

The stator core includes an annular portion (core) and a plurality of teeth portions 35, the annular portion being a stacked body of silicon steel sheets or the like, and being disposed coaxially with the shaft 1, the plurality of teeth portions 35 extending outward from the annular portion toward the magnet 22. An inner circumference surface of an annular portion 31 of the stator 3′ is fixed at the outer circumference surface of the sleeve 7.

The coil 33 is wound around each of the teeth portions 35 and indirectly fixed at the sleeve 7 via a base portion 31. The stator core and the coil 33 are insulated from each other by an insulator (not illustrated) formed of an insulating material. Note that, instead of the insulator, an insulating film may be coated at the surface of the stator core to insulate the stator core from the coil 33. Additionally, the base portion 31 is formed of a magnetic body, but may be formed of a non-magnetic body such as aluminum, plastic, and the like when there is no problem in characteristics, or the base portion 31 need not be present.

In the motor 200 according to the present embodiment, a magnetic field generated by applying a controlled current to the coil 33 causes attraction or repulsion acting between the coil 33 and the magnet 22, so that a rotational force acts at the magnet 22 and the shaft 1 rotates together, the magnet 22 being indirectly fixed at the shaft 1 via the rotor yoke 23.

The shaft 1 is fixed in a state of being fitted into the bearings 41 and 42. Two bearings 41 and 42, in other words, a first bearing 41 and a second bearing 42 are attached and lined at a constant interval at a lower of the shaft 1, the lower being opposite to a side, the disc portion 23a of the rotor 2 being fixed at the side. The first bearing 41 is located closer to an upper side, the disc portion 23a of the rotor 2 being fixed closer to the upper side. The second bearing 42 is located at a lower end side. The bearings 41 and 42 are accommodated in the sleeve 7.

The spring (elastic member) 5 is disposed between the pair of bearings 41 and 42, and thus preload is applied to the bearings 41 and 42. Also in the present embodiment, the vibration of the motor 200 can be suppressed by adjusting the spring 5 to an appropriate condition. The condition of the spring 5 will be described in detail later.

The outer circumference surface of the sleeve 7 is fixed at and supported by an inner circumference surface of the annular portion 31 of the stator. Thus, the shaft 1 is supported so as to be freely rotatable relative to the stator, and the rotational force of the motor 200 can be extracted from the shaft 1.

A suitable condition for the spring (elastic member) 5 used in the motor 100 and the motor 200 according to these embodiments will be described.

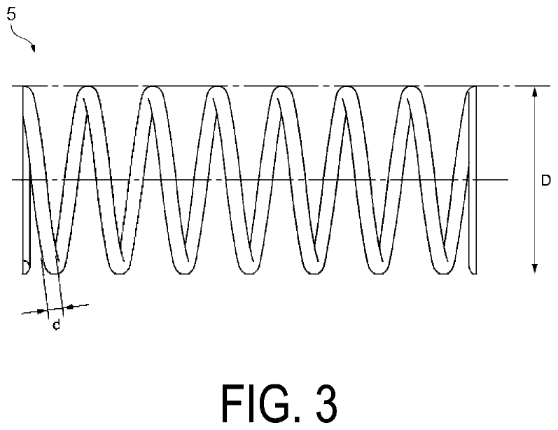

FIG. 3 is an enlarged view enlarged by extracting only the spring 5 used in the motor 100 and the motor 200 according to the above-described embodiments.

The appropriate condition for the spring 5 is to satisfy at least one of the two expressions described below.

$$Expression 1$$

$$S < \frac{20 d \sqrt{\frac{gG}{2 γ}}}{{π D}^{2}}$$

$$Expression 2$$

$$S > \frac{60 d \sqrt{\frac{gG}{2 γ}}}{{π D}^{2}}$$

A more appropriate condition for the spring 5 is to satisfy at least one of four expressions described below.

S<1.42×10⁴×d/D² Expression 1a

S<0.71×10⁴×d/D² Expression 1b

S>4.20×10⁴×d/D² Expression 2a

S>10.78×10⁴×d/D² Expression 2b

In each of the above expressions, D represents the outer diameter [m] of the spring 5, d represents the wire diameter φ [m] of the elastic member, S represents the no-load rotation number [rotation/min] (hereinafter, the unit may be abbreviated as “rpm”) of the shaft, γ represents the unit volume weight [kg/m³] of a material of the elastic member, and g represents gravitational acceleration. In particular, the corresponding positions of D and d are illustrated in FIG. 3, and this is common to all the expressions described below.

When a coil spring such as the spring 5 is subjected to an external impact, torsion is transmitted as a shock wave along an element wire of the spring 5. This shock wave is referred to as a surge wave, and the surge wave makes one round trip in a time T along the element wire of the spring 5, the time T being called a surge time.

When the spring 5 having a coil spring shape is subjected to vibration, in a case where there is a relationship such that a period of the vibration is equal to the surge time T, or the period of the vibration is ½ or ⅓ of the surge time T, a resonance phenomenon called surging occurs.

The surge time T can be calculated by the following Expression 3.

T=2πND/a Expression 3

In the above Expression 3, a surge velocity a is a speed when the surge wave moves along the element wire of the spring 5. This is common to all the expressions described below.

Additionally, the surge velocity a can be calculated by the following Expression 4.

$$Expression 4$$

$$a = \frac{1}{c} \sqrt{\frac{gG}{2 γ} + \frac{1}{1 + \frac{1}{2} {c}^{2}}}$$

In the above Expression 4, c represents a spring index of the spring 5, G represents a traverse elastic modulus of a material of the spring 5, γ represents the unit volume weight of the material of the spring 5, and g represents gravitational acceleration.

When √gG/2γ=k is set, the surge velocity a is represented by the following Expression 5.

$$Expression 5$$

$$a = \frac{1}{c} \times k \sqrt{\frac{1}{1 + \frac{1}{2} {c}^{2}}}$$

(Spring index c)=D/d, and typically, D is from approximately 5 to approximately 20 times larger than d, and thus approximation can be obtained as described in the following Expression 6.

$$Expression 6$$

$${( \frac{1}{a} )}^{2} = {\{ ( \frac{1}{k} ) \times c \}}^{2} = {\{ ( \frac{1}{k} ) \times ( \frac{D}{d} ) \}}^{2}$$

Thus, the following Expression 7 is derived.

(1/a)≈(1/k)×(D/d) Expression 7

From Expression 7 and the above Expression 3, the surge time T is represented by the following Expression 8.

$$Expression 8$$

$$T = \frac{2 π ND}{a} = 2 π ND \times \frac{1}{k} \times \frac{D}{d} = \frac{2 π N \times {D}^{2}}{k \times d}$$

The surge time T is the time for the spring 5 to make one round trip by the vibration due to the surging as described above, and a surge frequency fs of the vibration can be calculated by (1/T) as described above.

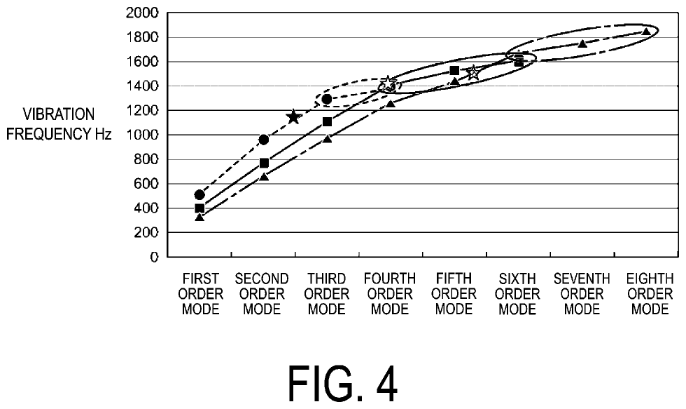

The present inventors prepared three types of springs with the number of turns (effective number of turns N) of 4, 6, and 8, and verified a generation state of vibration modes of the natural vibrations of the three types of springs by simulation. The results are shown in the graph in FIG. 4.

Note that FIG. 4 is a graph obtained by plotting orders of the vibration modes of the generated natural vibrations and vibration frequencies (Hz) of the natural vibrations on a horizontal axis and on a vertical axis, respectively. In FIG. 4, a graph of a broken line with a black circle ●, a graph of a solid line with a black square ▪, and a graph of the alternate long and short dash line with a black triangle ▴ show results of the springs having the effective number of turns N=4, N=6, and N=8, respectively.

The spring 5 used in the above-described embodiments has the effective number of turns N=6, as can be seen from FIG. 3. That is, in the present simulation, springs different from the spring 5 used in the above embodiments are also used. Thus, in the description related to the simulation, the reference numeral 5 may be omitted and “spring” may be simply referred to.

The condition of the simulation is as follows.
D=12.9 mm
d: 0.9 mm when the effective number of turns N=4, 1 mm when the effective number of turns N=6, and 1.1 mm when the effective number of turns N=8, (In order to be compressed to the same position when the same load is applied, the wire diameter d is increased as the number of turns is increased.)
Load*: 8N
*Load when an impact is applied to the spring 5 horizontally from the left in FIG. 3.

By the verification, as has been found and can be seen from the graph in FIG. 4, the vibration mode of the natural vibration of the spring is generated up to the same order as the effective number of turns N of the spring.

In addition, as has been found, the order of the vibration mode and the vibration frequency (Hz) of the natural vibration have a substantially proportional relationship in a small order, but the vibration order and the natural vibration number have no proportional relationship in an order exceeding ⅔ of the vibration mode of the maximum order for each spring.

Note that in FIG. 4, in each graph, a star is attached at a point corresponding to ⅔ of the vibration mode of the maximum order.

As has been found, the vibration frequency (Hz) of the natural vibration is generated in a relatively narrow frequency range in the vibration mode of the large order having no proportional relationship (see a region surrounded by an ellipse in each graph in FIG. 4).

As has been found by the present inventors, in a condition when a fundamental frequency (=the rotation number per second) of the rotation of the motor exceeds (a condition satisfying Expression 1a) or falls below (a condition satisfying Expression 2a) the surge frequency of a specific spring, resonance does not occur between the motor and the spring and the vibration is suppressed.

First, the condition satisfying Expression 1a will be described.

When the fundamental frequency of the motor is fin, and the surge frequency of the spring is fs, the following Expression 9 can express the motor fundamental frequency fin. This motor fundamental frequency fm is equal to or less than ⅔ of the maximum order vibration mode corresponding to the order mode times (=the number of turns times) of the surge frequency fs of the spring.

fm<⅔×N×fs Expression 9

When the above Expression 9 is rearranged, fm<⅔×N×(1/T) and fm<⅔×N×(k×d/2πND²) are obtained, and the following Expression 10 is derived.

fm<k×d/(3π×D²) Expression 10

Since the maximum rotation number of the motor is the no-load rotation number S, if no problem is assumed as long as the motor is used at lower than the no-load rotation number S, fm=S/60, so that the above Expression 10 can be converted into the following Expression 11.

S<20kd/πD² Expression 11

Although k=√gG/2γ is set in Expression 5 in order to simplify the expression, when k=√gG/2γ is substituted into Expression 11 in order to obtain a more accurate expression, the following Expression 1 as an appropriate condition for the spring is obtained.

$$Expression 1$$

$$S < \frac{20 d \sqrt{\frac{gG}{2 γ}}}{{π D}^{2}}$$

In a general spring material (spring steel), since G=7850 N/mm²=8.0×10⁹ kgf/m² and γ=7850 kg/m³, when these factors are applied to Expression 1, the following Expression 12 is obtained.

S<(20×0.22×10⁴/π)×d/D² Expression 12

When Expression 12 is rearranged, the following Expression 1a is derived as the condition appropriate for the spring.

S<1.42×10⁴×d/D² Expression 1a

That is, by designing the motor to satisfy the above Expression 1a, the resonance of the spring caused by rotation of the motor can be avoided, and thus the vibration of the motor can be reduced.

For example, when the effective number of turns N=6 of the spring is taken as an example, since the wire diameter d=1 mm and the outer diameter D=12.9 mm (hereinafter, this condition is referred to as “specific condition X”), the above Expression 1a is calculated as the following Expression 1a-1, and a preferable range of the no-load rotation number S (rpm) is obtained.

S<1.42×10⁴×1×10⁻³/(12.9×10⁻³)²≈85300 Expression 1a-1

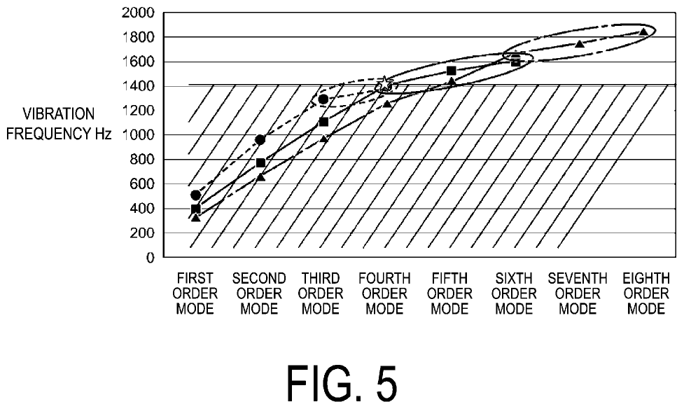

That is, in the specific condition X, a condition may be designed such that the no-load rotation number is less than 85300 rpm. With this condition, the motor is used below the point marked with the white star in the graph of the solid line of the effective number of turns N=6 in FIG. 4. This implies use of the motor in a region avoiding a narrow range of the vibration frequency (a range surrounded by an ellipse of about 1400 Hz to about 1600 Hz) downward, the natural vibrations of many orders (from fourth order mode to sixth order mode) being generated in the narrow range of the vibration frequency. In the specific condition X, the region satisfying the above Expression 1a is a diagonal line hatching region in the graph in FIG. 5. Note that FIG. 5 is a graph showing the region satisfying the above Expression 1a in the specific condition X by a diagonal line hatching in the graph in FIG. 4.

When the no-load rotation number is set so as to make a region to generate natural vibrations of many order modes, the natural vibrations resonating with the vibration generated by the rotation of the motor tend to be increased, and there is a concern. In this concern, the vibration may be amplified. However, by using the motor in a region other than this region, the vibration can be reduced.

Although the specific condition X is an example of the case of the effective number of turns N=6 of the spring, in the case of the effective number of turns N=4, by satisfying Expression 1a on the condition of the wire diameter d=0.9 mm and the outer diameter D=12.9 mm, the motor is used at a frequency lower than the vibration frequency (Hz) of the point marked with a black star in the graph of the broken line of the effective number of turns N=4 in FIG. 4. In addition, in the case of the effective number of turns N=8, by satisfying Expression 1a on the condition of the wire diameter d=1.1 mm and the outer diameter D=12.9 mm, the motor is used below the point marked with the hatched star in the graph of the alternate long and short dash line of the effective number of turns N=8 in FIG. 4.

Note that, in the above description, an example is described for convenience, and in the example, when the spring having fixed outer diameter D and wire diameter d is used, the no-load rotation number S is used in a predetermined range to satisfy the above Expression 1a. However, the motor may be designed to satisfy the above Expression 1a by appropriately selecting the outer diameter D and the wire diameter d of the spring in accordance with the no-load rotation number S required for the motor, or the motor may be designed to satisfy the above Expression 1a by appropriately combining and selecting all conditions.

In order to also prevent resonance with respect to the secondary harmonic component of the motor, it is necessary to set the rotation number to be further lower by 3 than the no-load rotation number S obtained by the above Expression 1a. That is, since the secondary harmonic component of the motor means twice the fundamental 3 frequency fm, it is desired to satisfy the following Expression 13 obtained by setting the left side of the above Expression 10 to “2fm”.

2fm<k×d/(3π×D²) Expression 13

When Expression 13 is rearranged similarly to the above Expression 10, the following Expression 1b as a more appropriate condition is derived.

S<0.71×10⁴×d/D² Expression 1b

That is, by designing the motor to satisfy the above Expression 1b, the resonance of the spring due to not only the fundamental frequency of the motor but also the secondary harmonic component can be avoided, and thus the vibration of the motor can be further reduced.

Next, a condition satisfying Expression 2 will be described.

The resonance between the motor and the spring can be considered to be avoided when the following Expression 14 and Expression 14a are satisfied. The following Expression 14 and Expression 14a express the fundamental frequency fm of the motor being larger than the vibration mode of the maximum order corresponding to the order mode times n (in other words, the same as the number N of effective number of turns) of the surge frequency fs (=1/T) of the spring.

fm>n×fs Expression 14

fm>N×(1/T) Expression 14a

Furthermore, when Expression 14a is rearranged using Expression 8, the following Expression 14b and Expression 14c are obtained.

fm>N×(k×d/2πND²) Expression 14b

fm>k×d/(2π×D²) Expression 14c

Since the practical rotation number of the motor is generally ½ of the no-load rotation number S, fm=½×S/60 is obtained. If no problem is assumed as long as the motor is used at ½ or more of the no-load rotation number S, the above Expression 14c can be converted into the following Expression 15.

S>60kd/πD² Expression 15

Although k=√gG/2γ is set in Expression 5 in order to simplify the expression, when k=√gG/2γ is substituted into Expression 15 in order to obtain a more accurate expression, the following Expression 2 as an appropriate condition for the spring is obtained.

$$Expression 2$$

$$S > \frac{60 d \sqrt{\frac{gG}{2 γ}}}{{π D}^{2}}$$

When G=7850 N/mm²=8.0×10⁹ kgf/m² and 7=7850 kg/m³ in a general spring material (spring steel) are applied to Expression 2, the following Expression 16 is obtained.

S>(60×0.22×10⁴/π)×d/D² Expression 16

When Expression 16 is rearranged, the following Expression 2a is derived as the condition appropriate for the spring.

S>4.20×10⁴×d/D² Expression 2a

That is, by designing the motor to satisfy the above Expression 2a, the resonance of the spring caused by rotation of the motor can be avoided, and the vibration of the motor can be reduced.

For example, when the above-described specific condition X having the effective number of turns N=6 of the spring is taken as an example, the above Expression 2a is calculated as the following Expression 2a-1, and a preferable range of the no-load rotation number S (rpm) is obtained.

S>4.20×10⁴×1×10⁻³/(12.9×10⁻³)²≈250000 Expression 2a-1

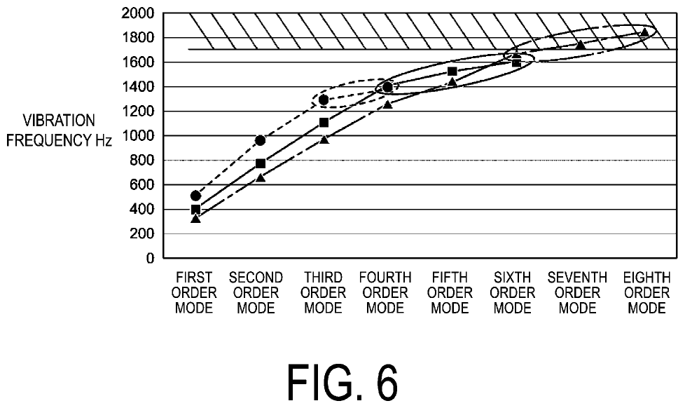

That is, in the specific condition X, a condition may be designed such that the no-load rotation number exceeds 250000 rpm. With this condition, the motor is used beyond the vibration frequency (Hz) at the point of the sixth order mode (maximum order mode) in the graph of the solid line of the effective number of turns N=6 in FIG. 4. This implies use of the motor in a region avoiding the highest vibration frequency (about 1600 Hz) upward, among the vibration frequencies generating the natural vibrations. In the specific condition X, the region satisfying the above Expression 2a is a diagonal line hatching region in the graph in FIG. 6. Note that FIG. 6 is a graph showing the region satisfying the above Expression 2a in the specific condition X by a diagonal line hatching in the graph in FIG. 4.

When the no-load rotation number is set in a region to generate a natural vibration of any order mode, the vibration generated by the rotation of the motor and the natural vibration of any order mode may resonate with each other, and there is a concern. In this concern, the vibration may be amplified. However, by using the motor in a region other than this region, the vibration can be reduced.

Although the specific condition X is an example of the case of the effective number of turns N=6 of the spring, in the case of the effective number of turns N=4, by satisfying Expression 2a on the condition of the wire diameter d=0.9 mm and the outer diameter D=12.9 mm, the motor is used beyond the vibration frequency (Hz) at the point of the fourth order mode (maximum order mode) in the graph of the broken line of the effective number of turns N=4 in FIG. 4. In addition, in the case of the effective number of turns N=8, by satisfying Expression 2a on the condition of the wire diameter d=1.1 mm and the outer diameter D=12.9 mm, the motor is used beyond the vibration frequency (Hz) at the point of the eighth order mode (maximum order mode) in the graph of the alternate long and short dash line of the effective number of turns N=8 in FIG. 4.

Note that, in the above description, an example is described for convenience, and in the example, when the spring having fixed outer diameter D and wire diameter d is used, the no-load rotation number S is used in a predetermined range to satisfy the above Expression 2a. However, the motor may be designed to satisfy the above Expression 2a by appropriately selecting the outer diameter D and the wire diameter d of the spring in accordance with the no-load rotation number S required for the motor, or the motor may be designed to satisfy the above Expression 2a by appropriately combining and selecting all conditions.

In order to prevent resonance of the bearing periodic component of the motor (referred to as the component of the period of the vibration generated by the ball in the ball bearing), the rotation number is required to be further higher than the no-load rotation number S obtained by the above Expression 2a. That is, since the bearing periodic component generally corresponds to 0.39 times the fundamental frequency, it is desirable to satisfy the following Expression 17 obtained by setting the left side of the above Expression 14c to “0.39fm”.

0.39fm>k×d/(2π×D²) Expression 17

When Expression 17 is rearranged similarly to the above Expression 14c, the following Expression 2b as a more appropriate condition is derived.

S>10.78×10⁴×d/D² Expression 2b

That is, by designing the motor to satisfy the above Expression 2b, the resonance with not only the fundamental frequency of the motor but also the bearing periodic component can be avoided, and thus the vibration of the motor can be further reduced.

As described above, the motor of the present invention is described with reference to the preferred embodiments, but the motor of the present invention is not limited to the configurations of the embodiments described above. For example, in the motor according to the above-described embodiment, two aspects are exemplified, in the two aspects, the magnet being indirectly fixed at the shaft to form the rotor, and the coil being indirectly fixed at the sleeve to form the stator. However, the present invention can also be applied to a motor, in the motor, the coil being indirectly fixed at the shaft to form the rotor and the magnet being indirectly fixed at the sleeve to form the stator.

Also, the fixation between either the shaft or the sleeve and the magnet or the coil may be not indirect but may be direct.

As the effective number of turns N of the spring (elastic member) to be used, the description is made only using 6 in the above-described embodiments and 4, 6, and 8 in the simulation, but the above-described embodiments and the simulation are not limitation and, for example. 9 or more or odd numbers may be used.

Note that, in the verification according to the simulation described above, a general spring material (spring steel) is used as the material of the spring (elastic member), and the expressions are calculated using the conditions such as the traverse elastic modulus G and the unit volume weight γ of the spring material, but the material of the spring (elastic member) is not limited to the general spring steel. Considering the characteristics required for the spring (elastic member), there is no large difference considered in conditions regardless of the material, and thus in the present invention, springs (elastic members) made of other materials can be applied as they are.

In addition, the motor according to the present invention may be appropriately modified by a person skilled in the art according to conventionally known knowledge. Such modifications are of course included in the scope of the present invention as long as these modifications still include the configuration of the present invention.

### REFERENCE SIGNS LIST

1 Shaft, 2 Rotor, 21, 22 Magnet, 23 Rotor yoke, 23a Disc portion, 23b Cylindrical portion, 3 Stator, 31 Annular portion, 32, 33 Coil, 34, 35 Teeth portion, 41 First bearing, 42 Second bearing, 41a, 42a Outer ring, 41b, 42b Inner ring, 41c, 42c Ball, 5 Spring (elastic member), 6 Housing, 61 Small diameter portion, 62 Large diameter portion, 63 Bottom plate, 64 Opening, 7 Sleeve, 100 Motor, 200 Motor

1. A motor comprising:
a shaft;
a pair of bearings fixed at the shaft;
a sleeve configured to accommodate the pair of bearings;
a magnet directly or indirectly fixed at one of the shaft and the sleeve;
a coil directly or indirectly fixed at the other of the shaft and the sleeve and opposing the magnet; and
an elastic member disposed between the pair of bearings, wherein,
the elastic member satisfies the following Expression 1:
$$Expression 1$$
$$S < \frac{20 d \sqrt{\frac{gG}{2 γ}}}{{π D}^{2}}$$
in the above Expression 1, D represents an outer diameter [m] of the elastic member, d represents a wire diameter φ [m] of the elastic member, γ represents a unit volume weight [kg/m³] of a material of the elastic member, and S represents a no-load rotation number [rotation/min] of the shaft, and g represents gravitational acceleration.

2. The motor according to claim 1, wherein
the elastic member satisfies the following Expression 1a:
S<1.42×10⁴×d/D² Expression 1a
in the above Expression 1a, D represents an outer diameter [m] of the elastic member, d represents a wire diameter φ [m] of the elastic member, and S represents a no-load rotation number [rotation/min] of the shaft.

3. The motor according to claim 1, wherein
the elastic member satisfies the following Expression 1b:
S<0.71×10⁴×d/D² Expression 1b
in the above Expression 1b, D represents an outer diameter [m] of the elastic member, d represents a wire diameter φ [m] of the elastic member, and S represents a no-load rotation number [rotation/min] of the shaft.

4. A motor comprising:
a shaft;
a pair of bearings fixed at the shaft;
a sleeve accommodating the pair of bearings;
a magnet fixed at one of the shaft and the sleeve;
a coil fixed at the other of the shaft and the sleeve and opposing the magnet; and
an elastic member disposed between the pair of bearings, wherein the elastic member satisfies the following Expression 2:
$$Expression 2$$
$$S > \frac{60 d \sqrt{\frac{gG}{2 γ}}}{{π D}^{2}}$$
in the above Expression 2, D represents an outer diameter [m] of the elastic member, d6 represents a wire diameter φ [m] of the elastic member, γ represents a unit volume weight [kg/m³] of a material of the elastic member, and S represents a no-load rotation number [rotation/min] of the shaft, and g represents gravitational acceleration.

5. The motor according to claim 4, wherein
the elastic member satisfies the following Expression 2a:
S>4.20×10⁴×d/D² Expression 2a
in the above Expression 2a, D represents an outer diameter [m] of the elastic member, d represents a wire diameter φ [m] of the elastic member, and S represents a no-load rotation number [rotation/min] of the shaft.

6. The motor according to claim 4, wherein
the elastic member satisfies the following Expression 2b:
S>10.78×10⁴×d/D² Expression 2b
in the above Expression 2b, D represents an outer diameter [m] of the elastic member, d represents a wire diameter φ [m] of the elastic member, and S represents a no-load rotation number [rotation/min] of the shaft.
